(19) United States
(12) Patent Application Publication
(10) Pub. No.: US 2025/0372611 A1
(43) Pub. Date: Dec. 4, 2025

(54) ELECTRODE FOR RECHARGEABLE BATTERY AND ELECTRODE ASSEMBLY INCLUDING THE SAME

(71) Applicant: Samsung SDI Co., Ltd., Yongin-si (KR)

(72) Inventor: Youngkwang Yun, Yongin-si (KR)

(73) Assignee: Samsung SDI Co., Ltd., Yongin-si (KR)

(21) Appl. No.: 19/009,868

(22) Filed: Jan. 3, 2025

(30) Foreign Application Priority Data
Jun. 4, 2024 (KR) 10-2024-0073297

(51) Int. Cl. H01M 4/133; H01M 4/02; H01M 4/583

(52) U.S. Cl. CPC H01M 4/133; H01M 4/583; H01M 2004/021

(57) ABSTRACT

An electrode for a rechargeable battery according to an embodiment of the present disclosure includes a substrate, and an active material layer formed on the substrate, the active material layer including a first region and a second region having respective porosities which are different from each other, wherein the porosity of the first region is greater than the porosity of the second region.

### CROSS-REFERENCE TO RELATED APPLICATIONS

This present application claims priority to and the benefit under 35 U.S.C. § 119(a)-(d) of Korean Patent Application No. 10-2024-0073297, filed on Jun. 4, 2024, in the Korean Intellectual Property Office, the entire disclosure of which is incorporated herein by reference.

### FIELD

The present disclosure relates to an electrode for a battery, and more particularly, to an electrode for a rechargeable battery and an electrode assembly including the same.

### BACKGROUND

As technical developments and demand for mobile devices have increased, demand for rechargeable batteries as an energy source has also increased.

A rechargeable battery may be formed by putting an electrode assembly, which is formed by placing electrodes on both side surfaces of a separator and winding them in the form of a jelly roll, or putting an electrode assembly, which is formed by stacking sheet-shaped electrodes and separators, together with an electrolyte in a case, and then sealing an opening of the case with a cap assembly.

The above disclosed information is only meant to enhance understanding of the background of the described technology, and therefore it may contain information that does not constitute the prior art that would already be known to a person of ordinary skill in the art.

### SUMMARY

The present disclosure provides an electrode and electrode assembly capable of preventing lithium precipitation even when current is concentrated toward an electrode tab.

An electrode for a rechargeable battery according to an embodiment of the present disclosure includes a substrate, an active material layer formed on the substrate, the active material layer including a first region and a second region having respective porosities which are different from each other, wherein the porosity of the first region is greater than the porosity of the second region.

The above active material layer may include artificial graphite and natural graphite, the first region of the active material layer may include relatively more artificial graphite than the second region, and the second region may include relatively more natural graphite than the first region.

Active material of the first region of the active material layer may be relatively more randomly oriented than active material of the second region of the active material layer.

A size of particles of active material in the first region may be 10 μm or less, and a size of particles of active material in the second region may be 30 μm or less.

A composite density of the first region may be 1.7 g/cc or less, and a composite density of the second region may be 1.85 g/cc or less.

The substrate may include an electrode active part where the active material layer is formed and an electrode uncoated region where the active material layer is not formed such that the substrate is exposed, and the electrode uncoated region may protrude from the substrate of the first region.

A width of the first region may be 5 mm to 20 mm.

The first region may be formed along one side of the substrate where the electrode uncoated region is formed.

The first region may be more hydrophilic than the second region.

An electrode assembly according to another embodiment includes a first substrate, a negative electrode including a negative active material layer formed on the first substrate, the negative active material layer including a first region and a second region having respective porosities which are different from each other, a positive electrode including a second substrate overlapping the negative electrode and an active material layer formed on the second substrate, and a separator disposed between the negative electrode and the positive electrode, wherein the porosity of the first region is greater than the porosity of the second region.

The negative active material layer may include artificial graphite and natural graphite, the first region may include relatively more artificial graphite than the second region, wherein the second region may include relatively more natural graphite than the first region.

An active material of the first region of the negative active material layer may be relatively more randomly oriented than active material of the second region of the negative active material layer.

A size of particles of active material in the first region may be 10 μm or less, and a size of particles of active material in the second region may be 30 μm or less.

A composite density of the first region may be 1.7 g/cc or less, and a composite density of the second region may be 1.85 g/cc or less.

The positive electrode, the negative electrode, and the separator may be alternately stacked and in sheet form.

The first substrate may include an electrode active part where the negative active material layer is formed and an electrode uncoated region where the negative active material layer is not formed such that the first substrate is exposed, and the electrode uncoated region may protrude from the first substrate at the first region.

A width of the first region may be 5 mm to 20 mm.

The first region may be formed along one side of the first substrate where the electrode uncoated region is formed.

The first region may be more hydrophilic than the second region.

By forming active material layers having different porosities as in the embodiment of the present disclosure, it is possible to prevent lithium precipitation due to current concentration at the electrode tabs.

### BRIEF DESCRIPTION OF THE DRAWINGS

The accompanying drawings illustrate preferred embodiments of the present disclosure and, together with the foregoing disclosure, serve to provide further understanding of the technical spirit of the present disclosure, but the present disclosure is not to be construed as being limited to the drawings.

FIG. 1 is a top plan view of an electrode included in a rechargeable battery according to an embodiment of the present disclosure.

FIG. 2 is a cross-sectional view taken along line II-II′ of FIG. 1.

FIG. 3 is a schematic top plan view of an electrode according to another embodiment of the present disclosure.

FIG. 4 is a photograph showing the contact angle of an electrolyte in an active material layer according to an embodiment of the present disclosure.

FIGS. 5 and 6 are photographs showing the spread of an electrolyte in the active material layer.

FIG. 7 is a schematic exploded perspective view of a rechargeable battery according to an embodiment of the present disclosure.

FIG. 8 is a graph for checking lithium precipitation according to a comparative example and an example.

### DETAILED DESCRIPTION

Hereinafter, embodiments of the present disclosure will be described in detail with reference to the accompanying drawings. It should be understood that the terms or words used in the specification and claims of the present disclosure are not be interpreted as limited by using typical or dictionary meanings, but rather as meanings and concepts conforming to the technical spirit of the present disclosure based on the principle that the inventor can appropriately define the concepts of the terms to best explain the present disclosure. Accordingly, it should be understood that the detailed description, which will be disclosed along with the accompanying drawings, is intended to describe the exemplary embodiments of the present disclosure and is not intended to represent all technical ideas of the present disclosure, and thus, it should be understood that various equivalents and modifications can exist which can replace the embodiments described in the present disclosure.

It should be further understood that the terms “comprise” and “include” and/or “comprising” or “including,” as used herein, specify the presence of stated features, numbers, steps, operations, elements, and/or components, but do not preclude the presence or addition of one or more other features, numbers, steps, operations, elements, components, and/or groups thereof.

In addition, to facilitate understanding of the present disclosure, the accompanying drawings are not drawn to actual scale, but the dimensions of some components may be exaggerated. In addition, like reference numbers may be assigned to like components in different embodiments.

Although the terms “first,” “second,” etc. are used to explain various constituent elements, the constituent elements are not limited to such terms. These terms are only used to distinguish one constituent element from another constituent element, and unless explicitly stated to the contrary, the second constituent element may be referred to as the first constituent element.

Throughout the specification, unless otherwise stated, each component may be singular or plural.

Spatially relative terms, such as “beneath,” “below,” “lower,” “above,” “upper,” etc. may be used herein to facilitate description of one element or a feature's relationship to another element(s) or feature(s) as shown in the drawings. Spatially relative position should be understood to encompass different directions of the device in use or operation in addition to the direction shown in the drawings. For example, if the device in the drawings is turned over, elements described as “below” or “beneath” other elements or features would then be oriented “on” or “above” the other elements or features. Thus, the exemplary term “below” can encompass both orientations of above and below.

It should be noted that if it is stated in the specification that one component is “connected to” or “coupled to” another component, a third component may be “connected,” “coupled,” and “joined” between the first and second components, although the first component may be directly connected, coupled, or joined to the second component.

The terms used in this specification are for describing embodiments of the present disclosure and are not intended to limit the disclosure.

The positive and negative electrodes of the rechargeable battery include active materials capable of intercalation and deintercalation of lithium ions, and transition metal compounds such as lithium cobalt oxide, lithium nickel oxide, and lithium manganese oxide are used as positive electrode active materials, and carbon-based active materials such as crystalline carbon or amorphous carbon and silicon-based active materials are mainly used as negative electrode active materials.

The rechargeable batteries are heavily loaded when charged at the electrode tabs where current is applied, and lithium precipitation occurs around the electrode tabs during periods of charging and discharging. This means that lithium precipitation is greater in the electrode tab portion where current is concentrated than in the central portion of the electrode where current is relatively less concentrated.

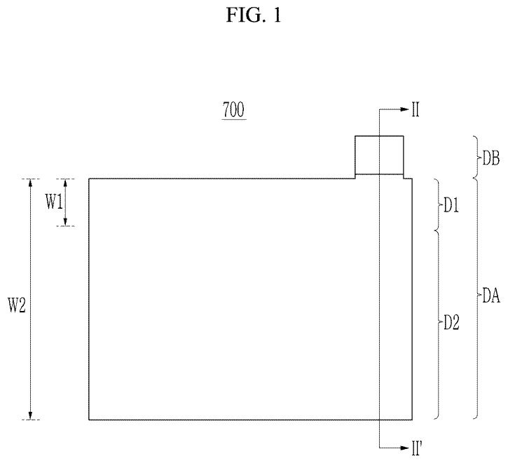

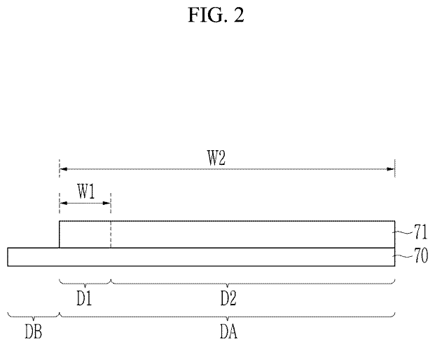

FIG. 1 is a top plan view of an electrode included in a rechargeable battery according to an embodiment of the present disclosure, and FIG. 2 is a cross-sectional view taken along line II-II′ of FIG. 1.

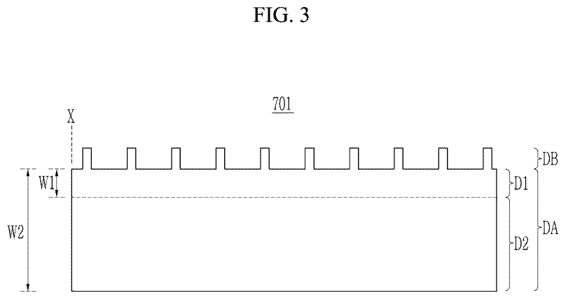

As shown in FIGS. 1 and 2, an electrode 700 according to an embodiment of the present disclosure includes a substrate 70 and an active material layer 71 formed on one surface of the substrate 70. The electrode is described as an example of a sheet-type electrode included in a stacked-type electrode assembly of a rechargeable battery described herein, but is not limited thereto and may also be used as an electrode of a winding-type electrode assembly as in FIG. 3.

The substrate 70 includes an electrode active part DA and an electrode uncoated region DB. The active material layer 71 may be formed on the electrode active part DA, and the electrode uncoated region DB does not have the active material layer 71 formed thereon, thereby exposing the substrate 70 at the electrode uncoated region DB. The electrode uncoated region DB may have a shape protruding from the electrode active part DA and may be used as an electrode tab for drawing current outward.

The active material layer 70 may include a first region D1 and a second region D2 having different porosities, and the porosity of the first region D1 may be greater than the porosity of the second region D2.

The second region D2 is a region that includes the center of the electrode, and the first region D1 is located relatively at the edge of the electrode. In this case, the first region D1 is an edge adjacent to the electrode uncoated region DB, and a width W1 of the first region D1 may be 5 mm to 20 mm.

The first region D1 includes particles having an average particle diameter D50 of 10 μm or less, and the active material particle size has a relatively uniform distribution compared to the active material particle size of the second region D2. The second region D2 includes particles having an average particle diameter D50 of 30 μm or less, and the active material particle size has a relatively uneven distribution compared to the active material particle size of the first region D1.

The average particle diameter D50 refers to the diameter of particles having a cumulative volume of 50% by volume in the particle size distribution. The average particle diameter D50 may be measured by methods well known to those skilled in the art-for example, by using a particle size analyzer, or by using a transmission electron microscope photograph or a scanning electron microscope photograph. Alternatively, measurements may be performed using a measurement device that uses dynamic light-scattering, and after performing data analysis to count the number of particles for each particle size range, the average particle diameter D50 value may be calculated from this.

Therefore, when applying the active material and applying the same pressure, the porosity of the first region D1 is formed to be greater than that of the second region D2, and the second region D2 may have a high composite density.

In this case, the composite density of the first region D1 may be 1.7 g/cc or less, the composite density of the second region D2 may be 1.85 g/cc or less, the capacity of the first region D1 may be 330 mAh/g to 350 mAh/g, and the capacity of the second region D2 may be 350 mAh/g to 370 mAh/g.

If the porosity of the first region D1 is formed to be greater than that of the second region D2 including the central portion, the accessibility of the active material of the electrolyte in the first region D1 may be improved.

The electrode 700 of FIG. 1 may be a negative electrode, and the negative electrode active material layer may include a negative electrode active material, a conductive material, and a binder.

The negative electrode active material may include a material capable of reversible intercalation/de-intercalation of lithium ion, lithium metal, an alloy of lithium metal, a material capable of doping and de-doping lithium, or a transition metal oxide.

The material capable of reversibly intercalating/de-intercalating lithium ions is a carbon-based negative electrode active material, and may include, for example, crystalline carbon, amorphous carbon, or a combination thereof. Examples of the crystalline carbon may be amorphous, sheet, flake, spherical or fiber-shaped natural graphite or artificial graphite, and examples of the amorphous carbon may be a soft carbon or hard carbon, mesophase pitch carbide, fired coke, or the like.

The lithium metal alloy may be lithium and an alloy of metals selected from the group consisting of Na, K, Rb, Cs, Fr, Be, Mg, Ca, Sr, Si, Sb, Pb, In, Zn, Ba, Ra, Ge, Al and Sn.

The material capable of doping and de-doping lithium may be an Si-based negative electrode active material or an Sn-based negative electrode active material. The Si-based negative electrode active material may include silicon, silicon-carbon composite, SiOx (0<x<2), an Si-Q alloy (wherein Q is an element selected from the group consisting of alkali metals, alkaline earth metals, a Group 13 element, a Group 14 element (excluding Si), a Group 15 element, a Group 16 element, a transition metal, a rare earth element, and a combination thereof), or a combination thereof. The Sn-based negative electrode active material may include Sn, SnO₂, an Sn-based alloy, or a combination thereof.

The silicon-carbon composite may be a composite of silicon and amorphous carbon. According to an embodiment, the silicon-carbon composite may be in the form of silicon particles and amorphous carbon coated on the surface of the silicon particles. For example, the silicon-carbon composite may include a secondary particle (core) assembled with silicon primary particles and an amorphous carbon coating layer (shell) disposed on the surface of the secondary particle. The amorphous carbon may also be disposed between the silicon primary particles, so that, for example, the silicon primary particles may be coated with the amorphous carbon. The secondary particles may exist dispersed in an amorphous carbon matrix.

The silicon-carbon composite may further include crystalline carbon. For example, the silicon-carbon composite may include a core including crystalline carbon and silicon particles and an amorphous carbon coating layer disposed on the surface of the core.

The Si-based negative electrode active material or Sn-based negative electrode active material may be used by mixing with a carbon-based negative electrode active material.

Meanwhile, the active material of the first region D1 may include more artificial graphite than the active material of the second region D2, and the active material of the second region D2 may include more natural graphite having a relatively higher orientation than the active material of the first region D1. Therefore, the active material of the first region D1 has a relatively small capacity but good charging characteristics due to the random orientation characteristics compared to the active material of the second region D2, and the active material of the second region D2 has relatively inferior charging characteristics due to the alignment characteristics compared to the active material of the first region D1, but the active material particles are stably disposed during charging, and the capacity characteristics and density may be high.

The active materials of the first region D1 may be relatively randomly oriented, and when the ratio of the peak intensity of a (002) plane to the peak intensity of a (110) plane of the first region D1 is set to 1 when measuring XRD using the CuKα line of the negative electrode, I₀₀₂/I₁₁₀ of the first region D1 may be 200 or more.

Additionally, the active materials in the second region D2 may have relative orientation. Having orientation means that the active materials in the second region D2 are better aligned than the active material particles in the first region D1 when oriented using magnetic force or the like, and may include an already oriented state.

The binder serves to adhere the negative electrode active material particles to each other and adhere the negative electrode active material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide-imide, polyimide or a combination thereof.

The aqueous binder may be selected from styrene-butadiene rubber, (meth)acrylate styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly (meth) acrylonitrile, ethylene propylene diene copolymer, polyvinyl pyridine, chlorosulfonated polyethylene, latex, polyester resin, (meth)acrylic resin, phenol resin, epoxy resin, polyvinyl alcohol, or a combination thereof.

If an aqueous binder is used as the negative electrode binder, a cellulose-based compound capable of providing viscosity may be further included. The cellulose-based compound may be a mixture of one or more of carboxymethyl cellulose, hydroxypropyl methylcellulose, methylcellulose, or alkali metal salts thereof. The alkali metals may be Na, K, or Li.

The dry binder is a polymeric material capable of being fiberized, and may be, for example, polytetrafluoroethylene, polyvinylidene fluoride, a polyvinylidene fluoride-hexafluoropropylene copolymer, polyethylene oxide, or a combination thereof.

The conductive material improves electrical conductivity of an electrode, and any electrically conductive material can be used as a conductive agent unless it causes a chemical change. Examples of the conductive material include carbon-based materials such as natural graphite, artificial graphite, carbon black, acetylene black, Ketjen black, carbon fibers, carbon nanofibers, and carbon nanotubes; metal-based materials in the form of metal powder or metal fibers, including copper, nickel, aluminum, and silver; conductive polymers such as polyphenylene derivatives; or mixtures thereof.

FIG. 3 is a schematic top plan view of an electrode according to another embodiment of the present disclosure.

As shown in FIG. 3, an electrode 701 according to another embodiment of the present disclosure includes a substrate and an active material layer formed on one surface of the substrate.

The electrode 701 shown in FIG. 3 is in the shape of a long strip in one direction and may be used as an electrode of a winding-type electrode assembly that is rolled around a winding axis X.

The substrate 70 includes the electrode active part DA and the electrode uncoated region DB, and a plurality of electrode uncoated regions DB may be formed along the length direction (or winding direction) of the substrate 70. The electrode uncoated regions DB formed in plural numbers may be folded toward the center of the electrode assembly after winding and may be electrically connected to each other by welding.

The active material layer includes the first region D1 and the second region D2 having different porosities, and the porosity of the first region D1 may be greater than the porosity of the second region D2. The second region D2 includes the center of the electrode, the first region D1 is disposed relatively to the edge of the electrode, and the first region D1 may be formed continuously along the length direction of the substrate. In this case, the first region D1 is adjacent to the electrode uncoated region DB, and the width W1 (or axial length) of the first region D1 is 5 mm to 20 mm.

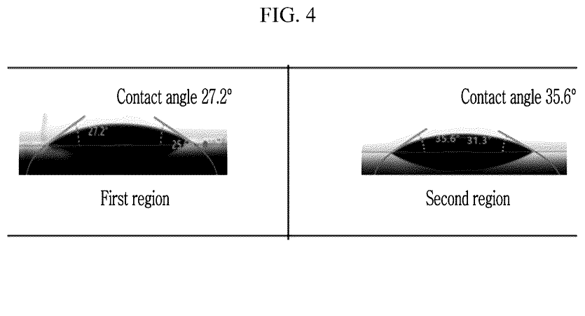

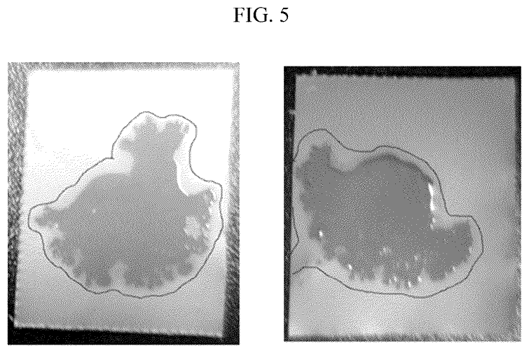

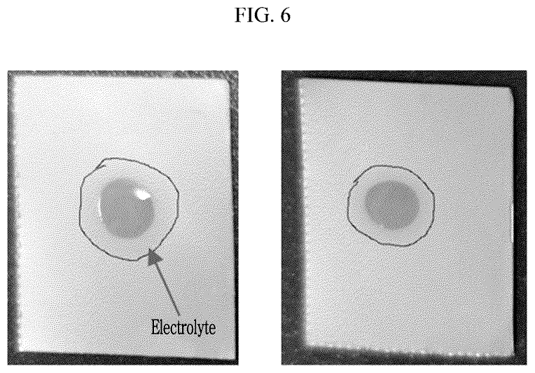

FIG. 4 is a photograph showing the contact angle of an electrolyte in an active material layer according to an embodiment of the present disclosure, and FIGS. 5 and 6 are photographs showing the spread of electrolyte in the active material layer.

Referring to FIG. 4, the contact angle of the electrolyte in the active material layer of the first region D1 is 27.2 degrees, and the contact angle of the electrolyte in the active material layer of the second region D2 is 35.6 degrees, and it can be seen that the contact angle of the first region D1 is smaller than the contact angle of the second region D2.

The contact angle becomes smaller as the hydrophilicity increases, and it can be seen that the first region D1 is relatively more hydrophilic than the second region D2. Therefore, as shown in FIG. 5, it can be seen that the electrolyte in the first region D1 is spread more widely than the electrolyte in the second region D2 of FIG. 6.

The first region D1 has a relatively smaller particle size than the active material particles of the second region D2, so that lithium ions may be easily inserted into the negative electrode active material. Therefore, the lithium precipitation phenomenon caused by current concentration may be reduced.

The electrodes of FIGS. 1 to 3 described above may be used as a negative electrode of a lithium rechargeable battery, and below, a stacked-type rechargeable electrode assembly including the electrode shown in FIG. 1 will be described with reference to the drawings.

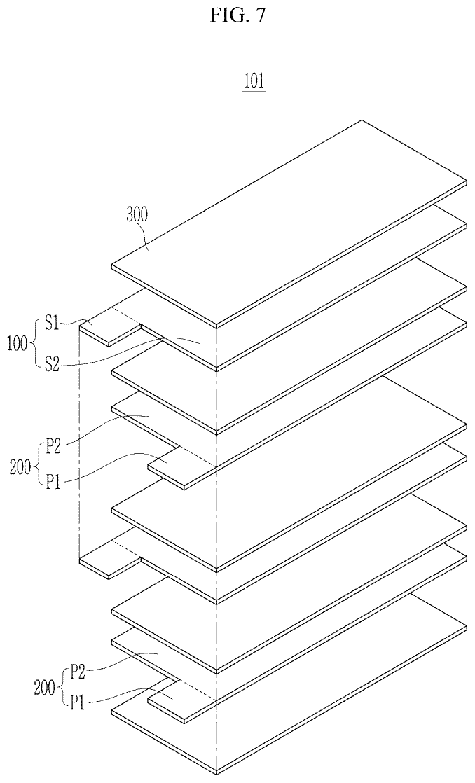

FIG. 7 is a schematic exploded perspective view of a stacked-type rechargeable battery according to an embodiment of the present disclosure.

As shown in FIG. 7, an electrode assembly 101 according to an embodiment of the present disclosure includes a positive electrode 100, a negative electrode 200, and a separator 300 in the form of sheets, and is a stacked-type electrode assembly in which the positive electrode 100 and the negative electrode 200 are disposed on both sides with the separator 300 therebetween, with the positive electrode 100 and the negative electrode 200 disposed in a repeating pattern.

The positive electrode 100 includes a positive electrode uncoated region S1 in which the substrate is exposed by not applying an active material to a substrate made of an aluminum metal plate, and a positive electrode active part S2 in which an active material layer is formed on the substrate.

As an active material forming the active material layer of the positive electrode, a compound capable of reversible intercalation and deintercalation of lithium (lithiated intercalation compound) may be used. Specifically, one or more types of composite oxides of lithium with metals selected from cobalt, manganese, nickel, and combinations thereof may be used. The content of the positive electrode active material may be 90% to 98% by weight based on the total weight of the positive electrode active material layer.

The active material layer of the positive electrode may further include a binder and a conductive material. In this case, the contents of the binder and the conductive material may be 1 wt % to 5 wt %, respectively, based on the total weight of the positive electrode active material layer.

The binder serves to adhere the positive electrode active material particles to each other and also to adhere the positive electrode active material to the substrate, which is a current collector. Representative examples of binders include, but are not limited to, polyvinyl alcohol, carboxymethyl cellulose, hydroxypropyl cellulose, diacetyl cellulose, diacetyl cellulose, polyvinyl chloride, carboxylated polyvinyl chloride, polyvinyl fluoride, polymers containing ethylene oxide, polyvinyl pyrrolidone, polyurethane, polytetrafluoroethylene, polyvinylidene fluoride, polyethylene, polypropylene, styrene butadiene rubber, acrylated styrene butadiene rubber, epoxy resin, nylon, or the like.

The conductive material improves electrical conductivity of an electrode, and any electrically conductive material can be used as a conductive agent unless it causes a chemical change.

The negative electrode 200 may be an electrode as shown in FIGS. 1 and 2, and may include an electrode uncoated region P1 in which the substrate is exposed by not applying an active material to a substrate made of a superior metal thin plate-for example, copper (Cu), and an electrode active part P2 in which an active material layer is formed on the substrate. The active material layer includes the first region D1 and the second region D2 having different porosities.

Again, referring to FIG. 7, for the separator 300, polyethylene, polypropylene, polyvinylidene fluoride, or a multilayer of two or more thereof may be used, or a mixed multilayer such as a two-layer separator of polyethylene/polypropylene, a three-layer separator of polyethylene/polypropylene/polyethylene, a three-layer separator of polypropylene/polyethylene/polypropylene, etc. may be used.

The separator 300 may include a porous substrate and a coating layer including an organic material, an inorganic material, or a combination thereof disposed on one or both surfaces of the porous substrate.

The porous substrate may be a polymer layer formed of any one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamide-imide, polybenzimidazole, polyether sulfone, polyphenylene oxide, cyclic olefin copolymer, polyphenylene sulfide, polyethylene naphthalate, glass fiber, Teflon, and polytetrafluoroethylene, or a copolymer or mixture of two or more thereof.

The organic material may include a polyvinylidene fluoride-based polymer or a (meth) acrylic-based polymer.

The inorganic material may include inorganic particles selected from, but not limited to, Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof.

The organic and inorganic materials may be mixed and present in one coating layer, or may be present in a stacked form with a coating layer containing an organic material and a coating layer containing an inorganic material.

The separator 300 may be formed larger than the negative electrode 200 and positive electrode 100, and may protrude outward from the negative electrode 200 and the positive electrode 100.

The electrode uncoated regions S1 and P1 of the repeatedly stacked positive electrode 100 and negative electrode 200 are electrically connected to each other with the same polarity and may be electrically connected to an external terminal. The electrode uncoated region S1 of the positive electrode 100 and the electrode uncoated region P1 of the negative electrode 200 may be spaced apart from each other and protrude in the same direction, but are not limited thereto, and may protrude in opposite directions.

The electrode assembly 101 may be used as a rechargeable battery by being accommodated in a square case (not shown) in the form of a pouch or can be together with an electrolyte, and the electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may be dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), or the like.

The ester-based solvent may be methyl acetate, ethyl acetate, n-propyl acetate, dimethyl acetate, methyl propionate, ethyl propionate, decanolide, mevalonolactone, valonolactone, caprolactone, or the like.

The ether-based solvent may be dibutyl ether, tetraglyme, diglyme, dimethoxyethane, 2-methyltetrahydrofuran, 2,5-dimethyltetrahydrofuran, tetrahydrofuran, or the like. In addition, the ketone-based solvent may be cyclohexanone, or the like. The alcohol-based solvent may be ethyl alcohol, isopropyl alcohol, or the like and the aprotic solvent may be nitriles such as R—CN (R is a C2 to C20 linear, branched, or cyclic hydrocarbon group and may include a double bond aromatic ring, or an ether bond), amides such as dimethylformamide, dioxolanes such as 1,4-dioxolane, sulfolanes, or the like.

The non-aqueous organic solvent may be used alone or in a mixture.

In addition, when using the carbonate-based solvent, a mixture of a cyclic carbonate and a chain carbonate may be used. In this case, the cyclic carbonate and the chain carbonate may be mixed in a volume ratio of 1:1 to 1:9.

The lithium salt is dissolved in a non-aqueous organic solvent, supplies a battery with lithium ions, operates the lithium secondary battery, and improves transportation of the lithium ions between the positive and negative electrodes. Examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN (SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and/or lithium bis(oxalato) borate (LiBOB).

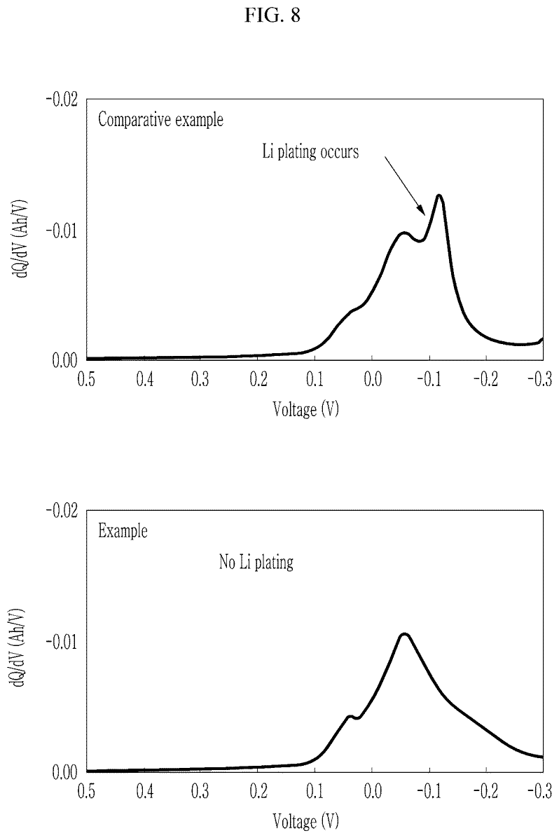

FIG. 8 is a graph for checking lithium precipitation according to a comparative example and an example.

In the example of FIG. 8, active material layers made of different active materials are formed in the first region and the second region of the negative electrode according to the present disclosure, and in the comparative example, active material layers made of the same active material are formed over the entire negative electrode according to the related art. In this case, the active material used in the related art may be the active material formed in the second region of the example.

The comparative example and the example measured dQ/dV according to voltage of a coin-shaped electrode assembly.

Referring to FIG. 8, it can be seen that the graph in the example shows increase and decrease in dQ/dV with increasing voltage, while the graph in the comparative example shows decrease in dQ/dV with increasing voltage around _{0.1} V due to lithium precipitation.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

1. An electrode for a rechargeable battery, comprising:
a substrate; and
an active material layer formed on the substrate, the active material layer including a first region and a second region having respective porosities which are different from each other,
wherein the porosity of the first region is greater than the porosity of the second region.

2. The electrode for the rechargeable battery as claimed in claim 1, wherein:
the active material layer includes artificial graphite and natural graphite;
the first region of the active material layer includes relatively more artificial graphite than the second region; and
the second region includes relatively more natural graphite than the first region.

3. The electrode for the rechargeable battery as claimed in claim 2, wherein active material of the first region of the active material layer is relatively more randomly oriented than active material of the second region of the active material layer.

4. The electrode for the rechargeable battery as claimed in claim 1, wherein:
a size of particles of active material in the first region is 10 μm or less; and
a size of particles of active material in the second region is 30 μm or less.

5. The electrode for the rechargeable battery as claimed in claim 4, wherein a composite density of the first region is 1.7 g/cc or less, and a composite density of the second region is 1.85 g/cc or less.

6. The electrode for the rechargeable battery as claimed in claim 1, wherein:
the substrate comprises an electrode active part where the active material layer is formed and an electrode uncoated region where the active material layer is not formed such that the substrate is exposed; and
the electrode uncoated region protrudes from the substrate at the first region.

7. The electrode for the rechargeable battery as claimed in claim 6, wherein a width of the first region is 5 mm to 20 mm.

8. The electrode for the rechargeable battery as claimed in claim 6, wherein the first region is formed along one side of the substrate where the electrode uncoated region is formed.

9. The electrode for the rechargeable battery as claimed in claim 1, wherein the first region is more hydrophilic than the second region.

10. An electrode assembly, comprising:
a first substrate;
a negative electrode including a negative active material layer formed on the first substrate, the negative active material layer including a first region and a second region having respective porosities which are different from each other;
a positive electrode including a second substrate overlapping the negative electrode and an active material layer formed on the second substrate; and
a separator disposed between the negative electrode and the positive electrode,
wherein the porosity of the first region is greater than the porosity of the second region.

11. The electrode assembly as claimed in claim 10, wherein:
the negative active material layer includes artificial graphite and natural graphite;
the first region includes relatively more artificial graphite than the second region; and
the second region includes relatively more natural graphite than the first region.

12. The electrode assembly as claimed in claim 11, wherein active material of the first region of the negative active material layer is relatively more randomly oriented than active material of the second region of the negative active material layer.

13. The electrode assembly as claimed in claim 10, wherein:
a size of particles of active material in the first region is 10 μm or less; and
a size of particles of active material in the second region is 30 μm or less.

14. The electrode assembly as claimed in claim 13, wherein a composite density of the first region is 1.7 g/cc or less, and a composite density of the second region is 1.85 g/cc or less.

15. The electrode assembly as claimed in claim 10, wherein the positive electrode, the negative electrode, and the separator are alternately stacked and in sheet form.

16. The electrode assembly as claimed in claim 10, wherein
the first substrate comprises an electrode active part where the negative active material layer is formed and an electrode uncoated region where the negative active material layer is not formed such that the first substrate is exposed; and
the electrode uncoated region protrudes from the first substrate at the first region.

17. The electrode assembly as claimed in claim 16, wherein a width of the first region is 5 mm to 20 mm.

18. The electrode assembly as claimed in claim 17, wherein the first region is formed along one side of the first substrate where the electrode uncoated region is formed.

19. The electrode assembly as claimed in claim 10, wherein the first region is more hydrophilic than the second region.
